(19) United States
(12) Patent Application Publication
(10) Pub. No.: US 2026/0227582 A1
(43) Pub. Date: Aug. 6, 2026

(54) Fiber-Coupled Optical System For Beam Shaping

(71) Applicant: Printoptix GmbH, Stuttgart (DE)

(72) Inventors: Simon Thiele, Stuttgart (DE); Nils Fahrbach, Stuttgart (DE)

(21) Appl. No.: 19/151,005

(22) PCT Filed: Jan. 18, 2024
(86) PCT No.: PCT/EP2024/051128

§ 371 Date: Jul. 25, 2025

(30) Foreign Application Priority Data
Jan. 27, 2023 (DE) 10 2023 102 056.0

(51) Int. Cl. G02B 6/38

(52) U.S. Cl. CPC G02B 6/3853

(57) ABSTRACT

A fiber-coupled optics for producing a non-Gaussian intensity profile, including an optical fiber with an end facet, and a beam-shaping optics located on the end facet, the beam-shaping optics being in the form of a micro-optics.

### CROSS-REFERENCE TO RELATED APPLICATIONS

This application is the United States national phase of International Patent Application No. PCT/EP2024/051128 filed Jan. 18, 2024, and claims priority to German Patent Application No. 10 2023 102 056.0 filed Jan. 27, 2023, the disclosures of which are hereby incorporated by reference in their entireties.

### BACKGROUND OF THE INVENTION

### Field of the Invention

The present invention relates to fiber-coupled optics for generating a non-Gaussian intensity profile. Furthermore, the present invention relates to an optical system for generating a non-Gaussian intensity profile using such fiber-coupled optics. The present invention also relates to an adapter for connection to a fiber connector with corresponding optics.

### Description of Related Art

Many optical applications require special intensity distributions of light. This applies in particular to applications in metrology, material processing, imaging or sensor technology, especially in the case of non-Gaussian distributed laser light.

To provide such a non-Gaussian intensity profile, it is known to provide suitable beam-shaping optics. The same is usually integrated into a free space beam. Beam-shaping optics are, for example, specially shaped lenses or other optics. A particular difficulty with conventional implementations is that in the case of a collimated beam, two free-form surfaces are usually required, wherein, in simplified terms, the first free-form surface redistributes the intensity profile of the incident beam and the second free-form surface corrects and flattens the wavefront of the redistributed beam. On the one hand, this requires two free-form surfaces with tight manufacturing tolerances, which are difficult to realize and therefore expensive. In this case, shape deviations of the free-form surfaces lead directly to non-collimated beam shaping conditions. In addition, the mechanical handling of perfectly manufactured free-form surfaces is also difficult. In particular, the free-form surfaces must be aligned with each other with high precision. This requires the adjustment of three spatial and three rotational degrees of freedom within the alignment process. This is particularly difficult and requires special mechanical handling or mounts, which further increases the complexity and therefore the cost of these systems.

The purpose of the present invention is to create a simplified and cost-effective optical setup for generating a non-Gaussian intensity profile.

The problem is solved by fiber-coupled optics, an optical system, and an adapter as described herein.

### SUMMARY OF THE INVENTION

The fiber-coupled optics for generating a non-Gaussian intensity profile or a non-Gaussian intensity distribution according to the present invention comprises an optical fiber having an end facet. Furthermore, the fiber-coupled optics has a beam-shaping optics which is arranged on the end facet. The beam-shaping optics is designed as a micro-optics. Since the beam-shaping optics is designed as micro-optics, it can be combined directly with the end facet of the optical fiber to provide integrated fiber-coupled optics. The beam-shaping optics is designed to generate a non-Gaussian intensity profile from the light provided by the optical fiber. In most optical setups, the light from laser sources is supplied via a glass fiber, optical fiber, optical waveguide or similar anyway. For the collimation of the light from the optical fiber, a further component is required in the prior art, so that collimated laser light is supplied to the respective optical setup in the prior art to generate the non-Gaussian intensity profile. As a result, the prior art requires a large number of individual components for collimation and forming, which makes the system even larger and more expensive. According to the present invention, the beam-shaping optics used, which are arranged at the end facet of the optical fiber, reshape the divergent light of the optical fiber and generates a non-Gaussian intensity profile from this. This simplifies the design by reducing the number of components required. At the same time, the beam-shaping optics, which is designed as micro-optics, can be manufactured cost-effectively.

Preferably, the non-Gaussian intensity profile has a top-hat profile, a donut profile, a rectangular profile, a square profile, a multi-spot profile. Alternatively, the beam-shaping optics can be used to generate a logo as an initial profile, which can then be displayed.

The micro-optics preferably has a diameter in the range of 50 μm to 1500 μm, preferably 200 μm to 500 μm. Due to the small dimensions of the micro-optics, integration with the optical fiber is possible. The optical system of the fiber-coupled optics can therefore be compact.

Preferably, the micro-optics has a diameter that essentially corresponds to the diameter of the optical fiber. This makes it possible to create an integrated system of the micro-optics with the optical fiber. Alternatively, the micro-optics has a diameter that is smaller than the diameter of the fiber so that the light leaving the core of the optical fiber can be suitably converted by the micro-optics. Known fibers usually have a cladding diameter of 250 μm or less and in particular 125 μm and a core diameter of less than 50 μm and in particular less than 15 μm.

Preferably, the micro-optics is created by means of 3D laser writing and in particular by means of 2-photon laser writing. It has been shown that 3D laser writing can be used to create suitable structures on an appropriate scale with the accuracy required to achieve a reliable non-Gaussian intensity distribution. In 3D laser writing, a photoresist is cured by a focused laser beam to create the desired structure. Thus, small structures can be formed precisely and the desired miniaturization of the micro-optics can be achieved. At the same time, the 3D laser writing method achieves a high level of reproducibility so that micro-optics with the desired optical properties can be reliably created. At the same time, the costs of such micro-optics are low.

The micro-optics is preferably monolithic. Due to the monolithic design of the micro-optics, it is possible to design the same particularly compact. Specifically, the orientation of the individual components of the beam-shaping optics relative to each other is fixed due to the monolithic design. Thus, alignment of the individual elements of the beam-shaping optics, as is required in the prior art, for example, is no longer necessary according to the present invention.

Preferably, the micro-optics is made of a transparent polymer. The transparent material is in particular an acrylate or an epoxy. Here, transparent refers to a property of the material to substantially transmit light in the near UV, the visible wavelength range and/or the near infrared. Here, substantially means that more than 50% of the light passes the material, preferably more than 70%, more preferably more than 90% and particularly preferred more than 95%.

Preferably, the micro-optics is produced directly on the end facet of the optical fiber and is thus directly and immediately connected to the end facet of the optical fiber. This can be achieved in particular by using the 3D laser writer to generate the micro-optics on the end facet of the optical fiber. As a result, the micro-optics is firmly and permanently connected to the end facet of the optical fiber. At the same time, the orientation of the micro-optics relative to the optical fiber can be fixed and is unchangeable due to the connection of the micro-optics to the end facet of the optical fiber. Subsequent alignment of the micro-optics relative to the end facet of the optical fiber is therefore no longer necessary. Alternatively, the micro-optics can be plugged or glued directly onto the end facet for connection to the optical fiber.

Preferably, the micro-optics are at least partially surrounded by a sleeve. This increases the mechanical stability of the micro-optics and protects the micro-optics against external influences or damage. In particular, the micro-optics are completely surrounded by a sleeve, wherein of course a light entry surface and a light exit surface of the micro-optics are not covered by the sleeve, so that light can pass through the micro-optics. In particular, one fiber end, which has the end facet of the optical fiber, is also at least partially surrounded by the sleeve. This further increases the mechanical stability of the micro-optics and protects the connection between the micro-optics and the optical fiber from external mechanical influences. The sleeve thus at least partially surrounds the micro-optics and one end of the optical fiber at the same time.

The micro-optics are preferably cylindrical. In particular, if a sleeve is provided for mechanical protection of the micro-optics, this sleeve is also cylindrical.

Preferably, the fiber-coupled optics has a ferrule, wherein the micro-optics and the optical fiber are arranged together in the ferrule. In particular, the fiber-coupled optics has a (fiber) connector with such a ferrule. However, the present invention is not limited to this, so that in embodiments a ferrule without a connector can also be provided. The micro-optics is thus connected to the end facet of the optical fiber by combining the optical fiber with the ferrule of a connector in particular. For example, the connector can be an F-SMA connector, an FC connector, an SC connector or a comparable fiber optic connector. Of course, the present invention is not limited to a specific connector type, so that the micro-optics can be integrated into a ferrule of different connectors in order to connect the same to the optical fiber.

Preferably, the micro-optics is arranged in an adapter, with the fiber having a fiber connector and the adapter having a receptacle for receiving the fiber connector. The adapter also has a recess, wherein the beam-shaping optics is arranged in the recess of the adapter. This makes it easy to connect the beam-shaping optics to an optical fiber that already has a fiber connector using the adapter. The adapter allows the beam-shaping optics to be connected to the end facet of the fiber in a unique alignment. In particular, the holder of the adapter is designed to accommodate the fiber connector in a form-fitting manner, so that a clear position of the fiber connector in the holder is defined. No further adjustment is required due to the design of the fiber connector and the adapter. In particular, the receptacle of the fiber connector is axially aligned with the recess which has the beam-shaping optics, so that the receptacle and the recess have a common optical axis.

Preferably, the micro-optics has an entry surface, which is arranged in the direction of the end facet, and an exit surface, which is arranged opposite the entry surface, so that light from the fiber enters the micro-optics through the entry surface and leaves the micro-optics via the exit surface or vice versa.

Preferably, the exit surface is designed as a free-form surface and/or diffractive surface. The free-form surface and/or the diffractive surface can be used to adjust the intensity distribution or intensity profile. The free-form surface acts as a refractive element, whereas the intensity profile is adjusted by the diffractive surface due to diffraction.

Preferably, the exit surface is designed as a flat surface. This means that the exit surface can be cleaned in the usual way and at the same time the surfaces of the beam-shaping optics, which lead to the non-Gaussian intensity distribution, are protected from external influences.

Preferably, the micro-optics has a cavity. The cavity is free of the transparent material that forms the micro-optics and can be filled with air or a gas, for example.

Preferably, the cavity has at least one inner surface, which is designed as a diffractive surface or free-form surface for adapting the intensity profile by refraction or diffraction. The inner surface can be arranged essentially perpendicular to the optical axis or essentially parallel to the exit surface and/or entry surface and/or the end facet of the optical fiber. In particular, the at least one inner surface can delimit the cavity in the direction of the entry surface or in the direction of the exit surface. In particular, the cavity has two inner surfaces, a first inner surface delimiting the cavity in the direction of the entry surface and a second inner surface delimiting the cavity in the direction of the exit surface, both the first inner surface and the second inner surface being designed as diffractive (in particular free-form) and/or refractive surfaces. The first inner surface and the second inner surface can be identical or different.

Preferably, the cavity of the micro-optics is open towards the end facet. This means that the cavity directly adjoins the end facet of the optical fiber. In particular, the cavity at the location of the end facet or at the location of the entry surface of the micro-optics has a diameter that is equal to or greater than the core of the optical fiber. This means that the micro-optics has no material at the end facet of the optical fiber. This is usually also the location of highest intensity. Particularly when transmitting high-power laser light, damage to the micro-optics can occur during the transition from the core of the optical fiber to the micro-optics due to the high intensity. However, since the micro-optics has a cavity at the location of the core of the optical fiber, such damage can be avoided. The light beam of the optical fiber, which emerges from the core, expands faster, so that when it enters the material of the micro-optics at a distance from the end facet, the intensity has already dropped, so that damage to the micro-optics is prevented.

Preferably, the micro-optics has exactly one free-form surface and/or diffractive surface for generating the non-Gaussian intensity profile.

Furthermore, the present invention relates to an optical system for generating a non-Gaussian intensity distribution with a fiber-coupled optics as described above. Furthermore, the optical system has focusing optics with at least one lens. By combining the fiber-coupled optics, which is arranged directly at the end facet of the optical fiber, and focusing optics, a collimated light beam can be generated which has a non-Gaussian intensity distribution.

Preferably, the at least one lens has a diameter in the range from 10 mm to 50 mm, preferably in the range from 20 mm to 30 mm. Thus, the at least one lens is a macroscopic lens, which in particular is not designed as micro-optics. This ensures a sufficiently large diameter of the light spot to be achieved.

Preferably, the distance between the fiber-coupled optics and the focusing optics is between 50 mm and 200 mm. In particular, the distance between the fiber-coupled optics and the focusing optics essentially corresponds to the focal length of the focusing optics. In this case, divergent light leaving the fiber-coupled optics at the exit surface is collimated by the focusing optics.

Preferably, the focusing optics has a zoom lens. In particular, the focusing optics has at least two lenses, which are designed, for example, as a diverging lens and a converging lens. The distance between the two lenses makes it easy to dynamically adjust the beam diameter.

Furthermore, the present invention relates to an adapter for connection to a fiber connector, wherein the adapter has an adapter element with a receptacle for receiving a fiber connector and in particular a ferrule of a fiber connector, for example an FC connector, an F-SMA connector, an SC connector or the like. Furthermore, the adapter has a recess in which beam-shaping optics is arranged, wherein the beam-shaping optics is designed as micro-optics. In particular, the beam-shaping optics is designed as described above.

### BRIEF DESCRIPTION OF THE DRAWINGS

In the following, the invention is described in more detail by means of preferred embodiments with reference to the accompanying Figures.

The terms Fig., Figs., Figure, and Figures are used interchangeably in the specification to refer to the corresponding figures in the drawings.

In the Figures:

FIG. 1 shows a prior art embodiment,

FIGS. 2A-2F show an embodiment of an optical system according to the present invention,

FIGS. 3A-3D show an embodiment of fiber-coupled optics according to the present invention,

FIGS. 4A and 4B show a further embodiment of an optical system according to the present invention,

FIG. 5 shows a further embodiment of an optical system according to the present invention,

FIG. 6 shows a further embodiment of an optical system according to the present invention,

FIGS. 7A and 7B show an embodiment of an adapter according to the present invention,

FIGS. 8A and 8B show a further embodiment of an optical system according to the present invention.

### DESCRIPTION OF THE INVENTION

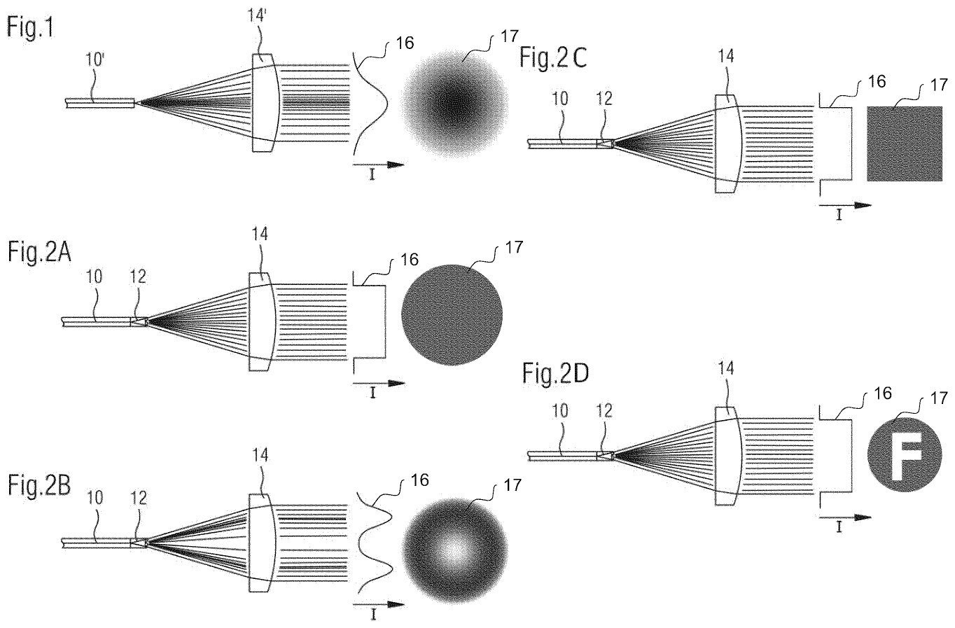

FIG. 1 shows prior art. Light, which is transported via an optical waveguide or an optical fiber 10′, emerges divergently at the end facet of the optical fiber 10′ and is collimated via a focusing lens 14′. However, this results in a Gaussian-shaped intensity distribution 16′, which is also shown in FIG. 1. The lens 14′ is, for example, a macroscopic lens with a diameter of 1 inch or 2 inches, which is arranged at a suitable distance from the end facet of the optical fiber 10′. The alignment of the lens 14′ relative to the optical fiber 10′ in all three spatial directions as well as tilting relative to the end facet of the optical fiber 10′ must be adjusted in order to obtain an optimally collimated output beam. FIG. 1 also shows the Gaussian intensity distribution in the area 17.

In the following Figures, identical or similar components are identified by the same reference symbols.

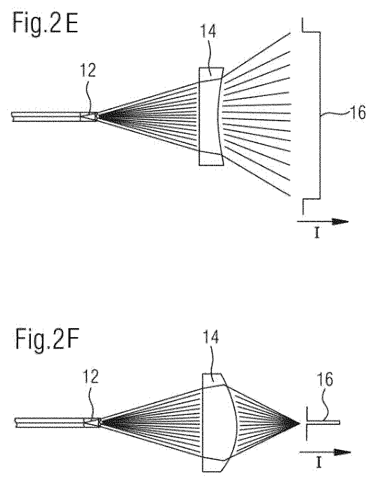

Reference is made hereinafter to FIGS. 2A to 2F. According to the present invention, beam shaping optics 12, which is designed as micro-optics, is arranged on an end facet of a fiber 10. Here, the beam-shaping optics 12 has a diffractive or refractive element by means of which the intensity distribution of the light emerging from the optical fiber 10 can be adjusted. However, the light is still divergent and is collimated via focusing optics 14. In FIG. 2A, collimated light with a top-hat intensity distribution 16 is achieved. FIG. 2A further shows the intensity distribution on a gray scale. This essentially corresponds to the generated spot or the light distribution when the light is directed onto a screen after the focusing optics 14. FIG. 2A shows the uniform distribution of the intensity in the area 17. Furthermore, a round intensity distribution is generated by the beam-shaping optics 12. In FIG. 2B, a donut-shaped intensity profile 16 with collimated light is achieved due to the design of the beam-shaping optics 12. The round intensity distribution in the area 17 thus produced is also shown in FIG. 2B. In FIG. 2C, a top-hat intensity profile is again generated in accordance with FIG. 2A, wherein in the embodiment of FIG. 2C the intensity distribution in the area 17 is squared. In FIG. 2D, a top-hat intensity profile is again generated in accordance with FIG. 2A, wherein in the embodiment of FIG. 2D the intensity distribution in the area 17 is round and, in addition, generates a logo (in this case, the letter “F”).

In FIG. 2E, the beam-shaping optics 12 is designed analogously to the beam-shaping optics of FIG. 2A, wherein the focusing optics 14 is designed as a diverging lens and thus a diverging light beam with a top-hat intensity distribution 16 is achieved. In FIG. 2F, a focused output beam is achieved with a top-hat intensity profile 16. Here, the beam-shaping optics 12 is formed identically or similarly to the beam-shaping optics of FIGS. 2A and 2E to achieve a top-hat intensity distribution. The focusing optics 14 is designed as a converging lens.

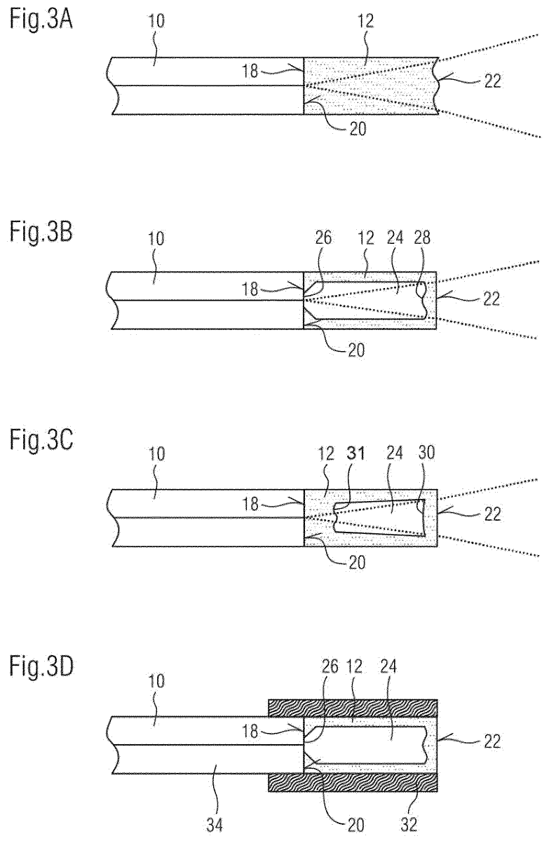

Reference is made in the following to FIGS. 3A to 3D, which show fiber-coupled optics according to the present invention. A beam-shaping optics 12 is arranged at an end facet 18 of an optical fiber 10. The beam-shaping optics 12 has a light entry surface 20 and a light exit surface 22. The beam-shaping optics 12 can be formed directly on the end facet 18 of the optical fiber 10, for example by means of 3D laser writing or 2-photon laser writing. It has been shown that 3D laser writing can be used to create suitable structures on an appropriate scale with the accuracy required to achieve a reliable non-Gaussian intensity distribution. In 3D laser writing, a photoresist is cured by a focused laser beam to create the desired structure. Thus, small structures can be formed precisely and the desired miniaturization of the micro-optics can be achieved. At the same time, the 3D laser writing method achieves a high level of reproducibility so that micro-optics with the desired optical properties can be reliably created. At the same time, the costs of such micro-optics are low. The micro-optics can be of monolithic design. Due to the monolithic design of the micro-optics, it is possible to design the same particularly compact. Specifically, the orientation of the individual components of the beam-shaping optics relative to each other is fixed due to the monolithic design. Thus, alignment of the individual elements of the beam-shaping optics, as is required in the prior art, for example, is no longer necessary according to the present invention.

In particular, the micro-optics is made of a transparent polymer. The transparent material is in particular an acrylate or an epoxy. Here, transparent refers to a property of the material to substantially transmit light in the near UV, the visible wavelength range and/or the near infrared. Here, substantially means that more than 50% of the light passes the material, preferably more than 70%, more preferably more than 90% and particularly preferred more than 95%.

The beam-shaping optics 12 is therefore directly connected to the optical fiber 10. Adjustment of the beam-shaping optics 12 relative to the optical fiber 10 is no longer necessary and is provided by the manufacturing process of the beam-shaping optics 12. In particular, the micro-optics has an outer diameter in the range from 50 μm to 1000 μm and preferably in the range from 200 μm to 500 μm. In particular, the outer diameter of the beam-shaping optics 12 essentially corresponds to the outer diameter of the optical fiber 10.

In particular, the beam-shaping optics is rotationally symmetrical about the optical axis of the optical fiber 10 and the beam-shaping optics 12 (common optical axis). However, this depends on the non-Gaussian intensity profile to be achieved. In the case of non-rotationally asymmetrical intensity profiles, the respective beam-shaping optics 12 can also be non-rotationally symmetrical.

In the embodiment shown in FIG. 3A, the exit surface 22 of the beam-shaping optics 12 has a free-form surface through which the intensity distribution or the non-Gaussian beam profile is generated.

In the embodiment shown in FIG. 3B, the beam shaping optics 12 has a cavity 24. The cavity 24 has an inner surface 28, which is arranged opposite the light-emitting surface 22 or points away from the light-emitting surface 22. The inner surface 28 of the cavity 24 is designed as a free-form surface to form the non-Gaussian beam profile or intensity profile. Furthermore, the cavity 24 has an opening 26 at the entry surface 20 of the beam-shaping optics 12. The opening 26 is thus arranged at the core of the optical fiber 10, i.e. at the location of the highest intensity of the light emerging from the end facet of the fiber 10. By providing the opening 26 at this location, damage to the material of the beam-shaping optics 12 can be avoided.

In the embodiment of FIG. 3C, the cavity 24 has a first inner surface 30 opposite the light exit surface 22 and a second inner surface 31 opposite the light entry surface 20, which faces away from the entry surface. In the example in FIG. 3C, the second inner surface 31 is designed as a free-form surface for generating the non-Gaussian beam profile or the non-Gaussian intensity distribution. The first inner surface 30 can be designed as a refractive or diffractive or combined refractive-diffractive surface for further adjustment of the beam profile or, for example, the collimation of the exiting light.

In the embodiment of FIG. 3D, which essentially corresponds to the embodiment of FIG. 3B, the beam-shaping optics 12 is also surrounded by a sleeve 32. The sleeve 32 completely surrounds both the beam-shaping optics 12 and one fiber end 34 of the optical fiber 10. The sleeve 32 can, for example, be designed as a metal sleeve or a plastic sleeve. In particular, the sleeve 32 can be made of a non-transparent material. Of course, the sleeve does not surround the end facet 18 of the fiber 10, the light entry surface 20 or the light exit surface 22 of the beam-shaping optics 12, so that the passage of light through the beam-shaping optics 12 is always guaranteed. The sleeve 32 improves the mechanical stability of the beam-shaping optics 12 and in particular its connection to the optical fiber 10 and protects the beam-shaping optics 12 from external mechanical influences.

In the embodiments of FIGS. 3B-3D, the light exit surface 22 is planar. This makes it easy to polish and/or clean this light exit surface. In particular, the respective free-form surface 28, 31 is protected by the beam-shaping optics 12 itself and, for example, a collision of the light exit surface with an object does not inevitably result in damage to the free-form surface 28, 31. This further increases the robustness of the fiber-coupled optics and thus, for example, minor damage can be repaired by polishing the light exit surface 22 without having to replace the entire beam-shaping optics 12.

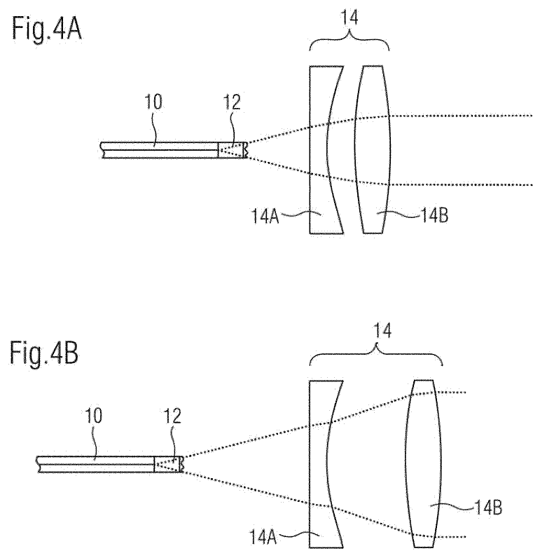

Reference is made hereinafter to FIGS. 4A and 4B. In FIGS. 4A, 4B, the focusing optics 14 has a zoom lens, which is formed by a first lens 14A and a second lens 14B. Here, for example, the first lens 14A is designed as a diverging lens and the second lens 14B as a converging lens. The beam diameter can be adjusted via the distance of the first lens 14A from the second lens 14b, as shown in the comparison of FIGS. 4A and 4B. If the distance between the first lens 14A and the second lens 14B is increased as shown in FIG. 4B, the beam diameter at the exit of the second lens 14B increases.

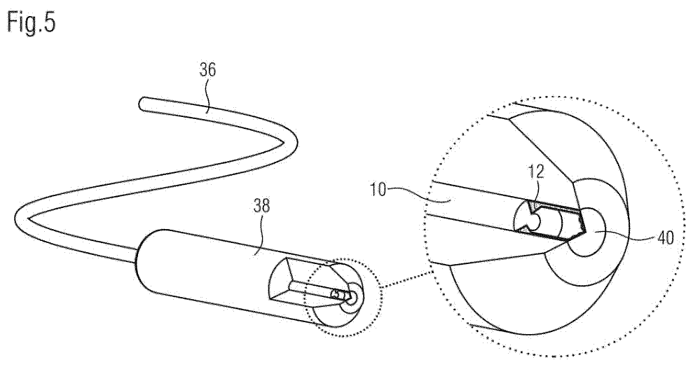

In the following, reference is made to FIG. 5. In this embodiment, the beam-shaping optics 12 is integrated into a ferrule 38, which is arranged at the end of an optical waveguide 36. Here, the optical fiber 10 of the optical waveguide 36 is arranged and fixed within the ferrule 38. Furthermore, the beam-shaping optics 12 is arranged within the ferrule 38 directly at an end opening 40 of the ferrule 38. Here, alignment of the optical fiber 10 relative to the beam-shaping optics 12 is ensured by the ferrule 38. In particular, the beam-shaping optics 12 can be created through the opening 40 in the ferrule 38 and subsequently the optical fiber can be inserted into the ferrule and, for example, bonded. Alternatively, the beam-shaping optics are created on the end facet of the optical fiber 10 and then inserted into the ferrule together. In particular, the ferrule is made of metal or ceramic, so that the highest possible positioning accuracy of the optical fiber 10 can be achieved, especially relative to the beam-shaping optics 12 and the opening 40.

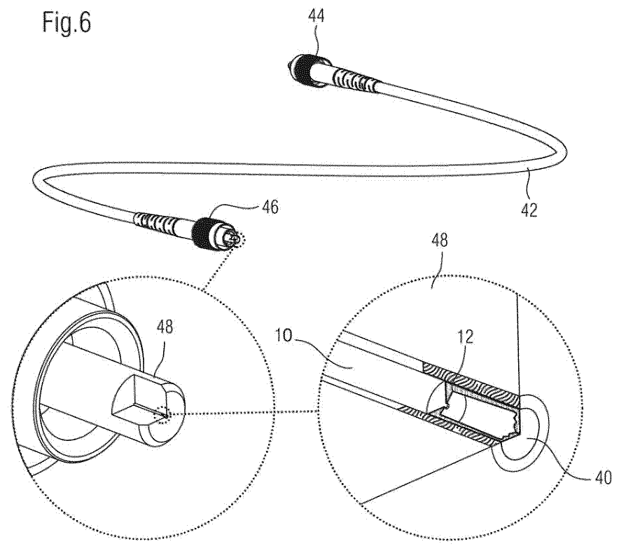

Reference is made below to FIG. 6, which shows an optical fiber 42 having connectors at its ends 44, 46. These connectors can be designed as FC connectors, for example. However, the present invention is not limited to this. In the example of FIG. 6, a first connector 46 has a ferrule 48, in which in turn an optical fiber 10 is held. Furthermore, a beam-shaping optics 12 is arranged in the ferrule 48 and has an opening 40 through which the light of the optical fiber 10 can exit the ferrule 48 through the beam-shaping optics 12. Thus, the connector 46 can be easily connected to an optical apparatus and provides light with a desired non-Gaussian intensity distribution. The light exiting from the optical fiber 10 can then be collimated using a macroscopic lens, as described above.

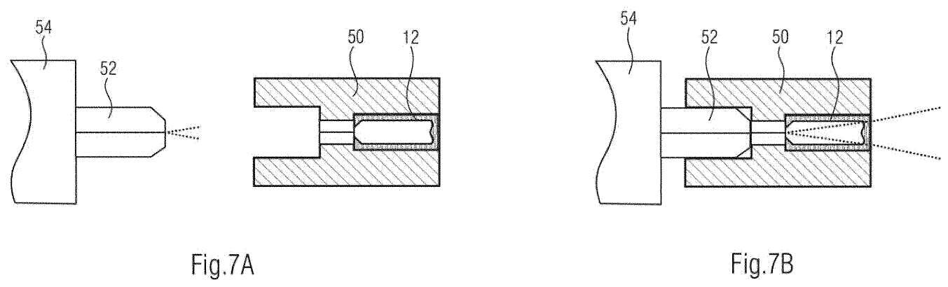

Reference is made hereinafter to FIGS. 7A and 7B. FIGS. 7A, 7B show an adapter 50 which can be connected to a ferrule 52 of a plug 54. The adapter 50 has a receptacle for receiving the ferrule 52 of the connector 54. Furthermore, the adapter 50 has a recess to accommodate the beam-shaping optics 12. The receptacle and recess of the adapter 50 have a common optical axis. By defining the position of the receptacle and the recess in relation to each other, a defined positional relationship can be created between the ferrule 52 of the optical fiber and the beam-shaping optics 12. In particular, the recess of the adapter 50 for the ferrule 52 is designed to fit the ferrule 52 precisely, so that an exact positional relationship to one another is guaranteed and can always be achieved. The connector 54 can therefore be easily adapted by attaching the adapter element 50. Different adapter elements can be provided, allowing different non-Gaussian intensity profiles to be generated. The individual adapters can be changed easily, for example by plugging them on, so that a quick change between the non-Gaussian beam profiles is possible.

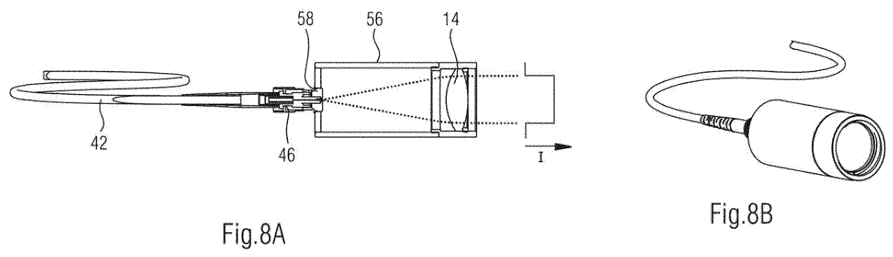

Reference is made hereinafter to FIGS. 8A and 8B. A connector 46 is provided here, which can be inserted into a connecting element 58, for example, and connected to it. Here, either the connecting element 58 according to the adapter of FIGS. 7A, 7B or the connector 46 itself according to FIG. 6 can have a beam-shaping optics 12, which is arranged directly on the end facet of the optical fiber 10. The system of FIGS. 8A, 8B further comprises a housing 56 in which the focusing optics 14 is arranged. This creates an integrated system for generating a non-Gaussian intensity profile. In the example in FIGS. 8A, 8B, this achieves a top hat intensity profile.

1. The fiber-coupled optics for generating a non-Gaussian intensity profile, comprising
an optical fiber with an end facet, and
beam-shaping optics, which is arranged on the end facet,
whereby the beam-shaping optics is designed as micro-optics.

2. The fiber-coupled optics according to claim 1, wherein the non-Gaussian intensity profile is a top-hat profile, a donut profile, a rectangular profile, a square profile, a multi-spot profile or a logo.

3. The fiber-coupled optics according to claim 1, wherein the micro-optics has a diameter in the range from 50 μm to 1500 μm, preferably 200 μm to 500 μm.

4. The fiber-coupled optics according to claim 1, wherein the micro-optics has a diameter which essentially corresponds to the diameter of the fiber.

5. The fiber-coupled optics according to claim 1, wherein the micro-optics is generated by means of 3D laser writing and in particular by means of 2-photon laser writing.

6. The fiber-coupled optics according to claim 1, wherein the micro-optics is made from a transparent polymer.

7. The fiber-coupled optics according to claim 1, wherein micro-optics is produced, plugged or glued directly onto the end facet.

8. The fiber-coupled optics according to claim 1, wherein the micro-optics is at least partially surrounded by a sleeve, in particular a fiber end which has the end facet also being at least partially surrounded by the sleeve.

9. The fiber-coupled optics according to claim 1, wherein the micro-optics is arranged in a ferrule, the ferrule being in particular part of a fiber connector.

10. The fiber-coupled optics according to claim 1, wherein the micro-optics is arranged in an adapter, wherein the fiber has a fiber connector and the adapter has a receptacle for receiving the fiber connector, the adapter further having a recess, wherein the beam-shaping optics is arranged in the recess of the adapter.

11. The fiber-coupled optics according to claim 1, wherein the micro-optics has an entry surface which is arranged in the direction of the end facet and has an exit surface opposite the entry surface, so that light from the fiber enters the micro-optics through the entry surface and leaves it via the exit surface or vice versa.

12. The fiber-coupled optics according to claim 11, wherein the exit surface is designed as a free-form surface and/or diffractive surface.

13. The fiber-coupled optics according to claim 11, wherein the exit surface is designed as a planar surface.

14. The fiber-coupled optics according to claim 1, wherein the micro-optics has a cavity.

15. The fiber-coupled optics according to claim 14, wherein the cavity has at least one inner surface, the inner surface being designed as a free-form surface and/or diffractive surface.

16. An optical system for generating a non-Gaussian intensity profile comprising fiber-coupled optics according to claim 1 and focusing optics comprising at least one lens.

17. The optical system according to claim 16, wherein, the at least one lens has a diameter in the range from 10 mm to 50 mm, preferably in the range from 20 mm to 30 mm.

18. The optical system according to claim 16, wherein the distance between the fiber-coupled optics and the focusing optics is between 50 mm and 200 mm.

19. The optical system according to claim 16, wherein the distance between the fiber-coupled optics and the focusing optics essentially corresponds to the focal length of the focusing optics.

20. An adapter for connection to a fiber connector, with an adapter element, the adapter element having a receptacle for receiving a fiber connector and a recess, with beam-shaping optics being arranged in the recess, the beam-shaping optics being designed as micro-optics.
